(19) United States
(12) Patent Application Publication
(10) Pub. No.: US 2023/0215284 A1
(43) Pub. Date: Jul. 6, 2023

(54) SYSTEM, DEVICE, METHOD, AND PROGRAM FOR PERSONALIZED E-LEARNING

(71) Applicant: NEC Corporation, Minato-ku, Tokyo (JP)

(72) Inventors: Kanishka KHANDELWAL, Tokyo (JP); Hiroshi TAMANO, Tokyo (JP)

(73) Assignee: NEC Corporation, Minato-ku, Tokyo (JP)

(21) Appl. No.: 18/008,542

(22) PCT Filed: Jun. 8, 2020
(86) PCT No.: PCT/JP2020/022473

§ 371 Date: Dec. 6, 2022

(51) Int. Cl. G09B 7/00

(52) U.S. Cl. CPC G09B 7/00

(57) ABSTRACT

A system 80 for personalized e-leaming includes a Hierarchical Knowledge Tracing (HKT) model unit 81 which includes two sequential models comprising of a lower level model and a higher level model, wherein the lower level model estimates and updates the estimate of knowledge state of a learner from a question-response data of the learner while the learner is active (in-session) on the e-leaming application and predicts the probability of answering a question within the domain using the estimate of knowledge state, and the higher level model updates the knowledge state estimate of the lower level model when a new session starts.

### TECHNICAL FIELD

The present invention relates to a system, a device, a method, and a program for personalized e-leaming.

### BACKGROUND ART

Over the past few decades, e-learning systems have emerged as a supporting/alternative infrastructure to the traditional classrooms for learning purposes. The e-learning system can identify and keep track of the knowledge/skill state of a learner using the data obtained from learner’s interaction with the system. As a result, e-learning systems offers the possibility of providing personalized learning experiences to the learners.

Knowledge tracing (KT) models are popularly used in Intelligent Tutoring Systems (ITS), a kind of e-learning system, to keep track of the learner’s knowledge/skill state over time. A KT model can be used to predict the performance of learner on future assessments. Further, it can be used to decide what questions or learning contents to provide to the learner next, thus personalizing the learning experience. Maintaining an accurate representation of students’ learning state in knowledge tracing models is important since it directly affects the learning outcome of a learner’s valuable time.

Various approaches to knowledge tracing have been proposed in the literature. The vanilla Bayesian knowledge tracing (BKT) model can model the learner’s skill in each concept separately. The estimated skill level can be used to determine whether to practice/leam the concept more or switch to a new concept. Recently, Deep knowledge tracing (DKT), a deep learning based model, have been proposed to model a learner’s skill level in multiple concepts simultaneously. Both the models, BKT and DKT, utilize the sequence of a learner’s interactions with the e-learning system. Each item within the sequence is a correctness of response (1 for correct and 0 for incorrect) on a question answered by the learner, along with its associated concept.

### CITATION LIST

### Non Patent Literature

[NPL 1] Chen, Yuying, et al., “Tracking knowledge proficiency of students with educational priors,” Proceedings of the 2017 ACM on Conference on Information and Knowledge Management, 2017.

[NPL 2] Zachary A. Pardos, et al., “Effective Skill Assessment Using Expectation Maximization in a Multi Network Temporal Bayesian Network,” The Young Researchers Track at the 20th International Conference on Intelligent Tutoring Systems, 2008.

[NPL 3] Haiqin Yang, and Lap Pong Cheung, “Implicit heterogeneous features embedding in deep knowledge tracing,” Cognitive Computation 10.1 (2018): 3-14.

[NPL 4] Lap Pong Cheung, and Haiqin Yang, “Heterogeneous features integration in deep knowledge tracing,” International Conference on Neural Information Processing, Springer, Cham, 2017.

### SUMMARY OF INVENTION

### Technical Problem

A learner can use the e-learning system for some days, months or even years. The time of interaction with the learner is usually collected in the e-learning system. The interactions between e-learning system and the learner happens in sessions. A session can be considered as a group of sequential interactions happening consecutively with the e-learning system that happens within a timeframe. Consequently, learner’s interaction data with the system can be divided into groups, each corresponding to a session. Suppose a learner utilizes the system on two separate occasions for 1 hour each. In this case, the learner can be said to have undergone two sessions on the system and his/her interaction data can be divided into two groups, each corresponding to a session.

The vanilla models and their proposed extensions consider the interaction data as a single sequence from one large session. These KT approaches haven’t explicitly considered the session structure within the learner’s data, from the modelling point of view.

Correspondingly, prior KT approaches may perform poorly since they try to capture the intra-session and inter-session dynamics of the learner’s knowledge state using a single model. As an example, a learner using an e-learning system to learn new words may show different online (during the session) and offline (off the system) learning behaviors. When the learner is online, the model should reflect his/her rapid learning/forgetting behavior which may be influenced by the working memory. But when the learner is offline the model should be able to capture the long term forgetting which may be influenced by the long term memory. Modelling the learner’s changing knowledge state within a session and across two sessions separately is expected to improve the performance of a KT model.

Non Patent Literatures (NPLs) 1, 2 utilized the session structure within the data from the modelling perspective. These approaches assume the knowledge state of a learner changes from one session to another. However, these models assume the knowledge state of a learner doesn’t change within a session. As a result, these models are not purely KT approaches and cannot be used for personalizing the learning experience of a learner within a session.

In an e-learning system, usually additional data about the learner, the learner’s interaction with the system and the learner’s environment are also collected. Various extensions have been proposed to BKT and DKT models utilizing this additional data to improve the performance on the KT task. NPLs 3, 4 propose to utilize additional features at the item-level. They have reported an increment in the performance over vanilla models at the task of predicting correctness on next problem given to the learner.

Some of the additional data collected in the e-learning system can be a characteristic of an item in the interaction while some can be a characteristic of the session as a whole. For example, time taken, hint used or not, etc. are item-level data while the number of questions skipped in a session, device type (mobile or desktop), location (home or classroom) are session-level data. The prior KT approaches fail to provide a framework to consider the two distinct feature types separately.

Furthermore, learning of a concept may happen between two consecutive sessions of the e-learning system. There could be many external factors that affect the learning of a student such as offline learning (learning from sources such as video, text, etc. provided in the e-learning system or from external sources), social interactions with students and teachers, self-pondering, etc. If the information about learning caused by external factors is made available to the e-learning system, it should be utilized to update the knowledge state of learner before the next session begins.

One of the objects of the present invention is to provide a system, a device, a method, and a program for personalized e-learning that is capable of modelling the learner’s changing knowledge state within a session and across two sessions separately.

### Solution to Problem

A system for personalized e-learning according to the present invention includes: a Hierarchical Knowledge Tracing (HKT) model unit including two sequential models comprising of a lower level model and a higher level model, wherein the lower level model estimates and updates the estimate of knowledge state of a learner from a question-response data of the learner while the learner is active (in-session) on the e-learning application and predicts the probability of answering a question within the domain using the estimate of knowledge state, and the higher level model updates the knowledge state estimate of the lower level model when a new session starts.

A device for personalized e-learning according to the present invention includes: a Hierarchical Knowledge Tracing (HKT) model unit including two sequential models comprising of a lower level model and a higher level model, wherein the lower level model estimates and updates the estimate of knowledge state of a learner from a question-response data of the learner while the learner is active (in-session) on the e-learning application and predicts the probability of answering a question within the domain using the estimate of knowledge state, and the higher level model updates the knowledge state estimate of the lower level model when a new session starts.

A method for personalized e-learning according to the present invention includes: estimating and updating the estimate of knowledge state of a learner from a question-response data of the learner while the learner is active (in-session) on the e-learning application; predicting the probability of answering a question within the domain using the estimate of knowledge state; and updating the knowledge state estimate when a new session starts.

A program for personalized e-learning according to the present invention causes a computer to perform a process including: estimating and updating the estimate of knowledge state of a learner from a question-response data of the learner while the learner is active (in-session) on the e-learning application; predicting the probability of answering a question within the domain using the estimate of knowledge state; and updating the knowledge state estimate when a new session starts.

### Advantageous Effects of Invention

According to the present invention, it is possible to model the learner’s changing knowledge state within a session and across two sessions separately.

### BRIEF DESCRIPTION OF DRAWINGS

FIG. 1 is a block diagram showing an example of an environment 1000 according to an exemplary embodiment of the present invention.

FIG. 2 is a block diagram showing an example of an environment 1001 according to an exemplary embodiment of the present invention.

FIG. 3 is an explanatory diagram showing an example of two learning trajectories that learners can have within a session to achieve a mastery in the skill (i.e. skill level goes from zero to one).

FIG. 4 is an explanatory diagram showing an example of hierarchical KT model implemented using neural networks with vanilla RNN used for sequential modelling.

FIG. 5 is a flowchart showing an example of the operation of the user device 100 and the server 300 according to the exemplary embodiment of the present invention.

FIG. 6 is a flowchart showing an example of the operation of the user device 2000 and the server 4000 according to the exemplary embodiment of the present invention.

FIG. 7 is a flowchart showing an example of the operation of the higher level model 364 according to the exemplary embodiment of the present invention.

FIG. 8 is a flowchart showing an example of the operation of the higher level model 4520 according to the exemplary embodiment of the present invention.

FIG. 9 is a flowchart showing an example of the operation of the content delivery model 340 according to the exemplary embodiment of the present invention.

FIG. 10 is a schematic block diagram showing a configuration example of a computer according to the exemplary embodiments of the present invention.

FIG. 11 is a block diagram showing an outline of a system according to the present invention.

### DESCRIPTION OF EMBODIMENTS

Embodiments of the present invention are directed to a two-level hierarchical KT model comprising of a lower and a higher level model. The lower level model is responsible for tracing the learner’s knowledge state within a session while the higher level model is responsible for modelling inter-session dynamics of knowledge state and update the learner’s knowledge state at the end of session to accurately represent the one at the beginning of next session.

The lower level model is a KT model that traces the knowledge state of a learner while the learner is active on the e-learning system. It maintains the estimate of the knowledge state of learner within a session. Further, with an interaction of the learner on the system, it takes as input the corresponding interaction data of a learner comprising of the question that the learner attempted, the response to it and some additional item-level features made available to the system. It uses this data to update its estimate of the knowledge state of the learner. The updated knowledge state can be used to predict probability of that the learner to correctly answer next question. These probabilities can be used to personalize the learning plan of learner. For example, the question with least probability can be presented next to facilitate a faster path towards proficiency. In this way, the lower level model traces the knowledge state of a student till the time learner is active on the system.

The higher level model takes as input the knowledge state at the end of a session from the lower level model (as is or after transformation) as its input and updates it to represent the leaner’s knowledge state at the beginning of a next session. The higher level model may take as inputs additionally some aggregated session information from the lower level model and/or session-level features and/or inter-session features, examples of each can be, the total number of skips within the session, device type used in the session and a learning content consumed between the two sessions respectively. The hierarchical model comprising of higher and lower level models along with other learnable components are trained using the data of learners who used the e-learning system to achieve their learning goals.

Knowledge tracing is defined as the process of modeling the knowledge state of a learner over time. Generally speaking, KT models utilize the learner’s response data to the question asked sequentially through the e-learning system as an evidence of the skill level and correspondingly update their estimate of knowledge state of a learner. This estimate can be used to predict the learner’s performance on subsequent assessments. For example, the model can predict the probability of correctly answering a given question correctly in the future.

Bayesian Knowledge Tracing (BKT) was the first model proposed for the KT task. BKT assumes each question has a corresponding skill/knowledge component/concept associated to it. It is a single skill model and the model needs to be applied for each skill separately. It assumes that the skill state of a learner can only be binary (i.e. mastered or not). The BKT model performs poorly in the practical settings since the assumption that the skill state can only be binary doesn’t hold well in reality. Moreover, BKT doesn’t assume the skill correlations and how learning in one skill affects the others.

Recently, many deep learning (DL) based approaches have been proposed for the KT task that have shown significant boost in performances on real-world datasets. Most of the proposed DL approaches utilize a sequential model such as Long-Short Term Model (LSTM)/Gated Recurrent Unit (GRU)/Recurrent Neural Network (RNN) that are trained on the sequential response data for the KT task. The hidden vector in the models can be interpreted as the knowledge state vector of a learner that gets updated with each new interaction with the system. A combination of linear and non-linear transformations can be applied on the hidden vector to predict the probabilities of correctly solving the questions in the modelled domain.

In real-world settings, learners usually access the learning systems on a session to session basis. A session can be defined as a group of interactions that happen within a timeframe. Such session structure in the learning behavior induces a hierarchical pattern within the recorded response data. For a learner who has 5 sessions on the system, the learner’s data can be organized into a sequence of sessions which will be of length 5, each element within the sequence being itself a sequence of responses.

In most cases, e-learning systems log the timestamps of user interactions with the system. Sometimes, a learner is asked to log in to the system in order to access the learning content. As a result, it becomes fairly straightforward to figure out the session structure within the data. As the sequence of responses is used to estimate the knowledge state, utilizing the information about the sequence of sessions could help in improving the estimations. Thus, a system with two-level model i.e. two sequential models arranged in a hierarchical manner could be better for the KT modelling task as it can separately capture the within-session and across-sessions learning dynamics.

The following example highlights the importance of modelling the across-session dynamics using the session sequence information. Suppose a learning system is built for learning a single skill by practicing on the questions associated to this skill and it employs any of the prior KT approach that ignores the session structure and assumes that the complete sequence of interactions is as if from a single session. Consider a scenario A in which a learner solves multiple questions in a single session and the employed KT model estimates that the learner has achieved mastery in the skill. Now, consider a scenario B in which the same learner utilizing the same system achieves mastery of the skill according to the KT model after performing several sessions spanned over a week. Now, if we ask the model to predict the performance of learner on this skill after a fixed time, in both the scenarios, the predictions of the KT model will be the same if the learner is no longer allowed to use the system or learn from external source. This is because the learner is same in both scenarios and the KT would assume a same forgetting behavior of the learner. However, in real-world the actual probabilities may not be equal. The spacing effect refers to the finding that long-term memory is enhanced when learning events are spaced apart in time, rather than massed in immediate succession. As a result, the prediction by the model in scenario B should be high. Thus, the prior KT approaches have shortcomings when it comes to modelling the across-session dynamics.

Accordingly, embodiments of the present invention are directed to a two-level hierarchical KT model where the lower level model takes into account the change in knowledge state due to series of interactions while the higher level model takes into account the effect of session-level behavior on the knowledge state.

The lower level model traces the knowledge state of a learner from the beginning of a session till the end of session. The estimated knowledge state can be used to output predicted probabilities that the learner will answer the question correctly. These probabilities can be used to personalize the learner’s e-learning plan. For example, predetermined thresholds can be applied to determine when to move on to the next question type, what the next question type should be, when to remove particular questions from a learning plan, etc.

Once the learner has answered the question, this interaction is fed back into the lower level model to update the learner’s knowledge state. In the update process, the lower level model accepts as an input a representation of the learner’s last interaction and accesses the current knowledge state for the learner, and further outputs an updated knowledge state for the learner.

As the new session begins, the higher level model updates the knowledge state obtained from the lower level model in the last session to better represent the learner’s current knowledge state. A new session could be a simple access/log in to the system followed or not followed by any activity (such as solving questions) by the learner on the e-learning application.

As such, implementations described herein provide a deep learning based knowledge tracing tool that models the likelihood that a learner will answer a particular question correctly. The implementation is based on a machine learning based model where the response data of multiple learners is used to train the model and get the optimal weights and parameters of the two models.

### Exemplary E-Learning System with the Hierarchical Model

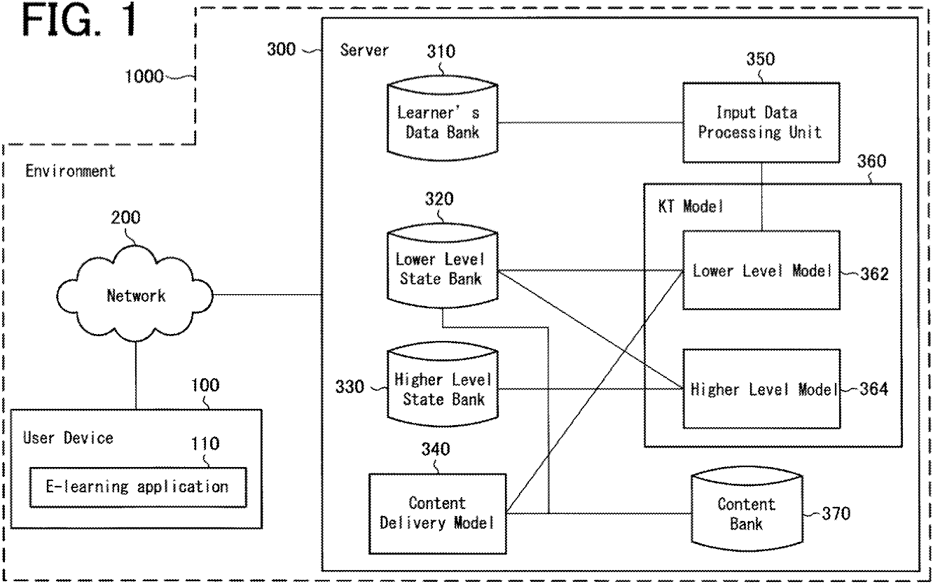

FIG. 1 is a block diagram showing an example of an environment 1000 according to an exemplary embodiment of the present invention. Referring now to FIG. 1, a block diagram of exemplary environment 1000 suitable for personalized e-learning based on a basic hierarchical KT model is shown. Environment 1000 includes user device 100 having e-learning application 110. Generally, e-learning application 110 provides a personalized e-learning environment to the user and facilitates periodic assessments such as quizzes or assignments. User device 100 can be any kind of computing device capable of facilitating periodic assessments. In embodiments, user device 100 can be a personal computer (PC), a laptop computer, a workstation, a mobile computing device, a personal digital assistant (PDA), a cell phone, or the like.

Environment 1000 includes server 300 that includes the hierarchical KT model 360. In this embodiment, server 300 provides access to KT model 360 via network 200. Server 300 can be any kind of computing device capable of facilitating modeling of knowledge tracing. In embodiments, server 300 can be a PC, a laptop computer, a workstation, a mobile computing device, a PDA, a cell phone, or the like. The components of environment 1000 may communicate with each other via a network 200, which may include, without limitation, one or more local area networks (LANs) and/or wide area networks (WANs). Such networking environments are commonplace in offices, enterprise – wide computer networks, intranets, and the Internet.

In the embodiment shown in FIG. 1, user device 100 includes e-learning application 110, whose one of many functionalities is to show a question to the user and in some cases along with some possible options to choose the response from. Another important functionality of e-learning application 110 is to send the learner’s interaction data to the server 300.

Similarly, in this embodiment, server 300 includes KT model 360, content bank 370, learner’s data bank 310, input data processing unit 350, content delivery model 340, and lower level state bank 320 and higher level state bank 330, as knowledge state banks, for the lower level model 362 and the higher level model 364 respectively in the hierarchical KT model 360. Although the components of server 300 are depicted as a part of (e.g., installed on or incorporated into) server 300, in some embodiments, some or all of these components, or some portion thereof, can be located elsewhere, such as on user device 100, in a distributed computing environment within which server 300 resides, and the like.

In the embodiment shown in FIG. 1, the server 300 includes a content delivery model 340. This model usually determines which question (or sometimes learning aide) to provide to the learner based on the e-learning plan of the learner. To facilitate this determination, the content delivery model 340 takes in the knowledge state of learner from the lower level state bank 320 and communicates with lower level model 362. Generally, lower level model is able to predict the learner’s probabilities of solving the questions within the learning domain correctly. Content delivery model 340 can utilize this information to deliver a content from content bank 370 according to the personalized e-learning plan.

Hierarchical KT model 360 models knowledge tracing. As a general matter, the interactions of a learner until time T can be denoted by set of sessions S = {S₁, S₂, ■ ■ ■ , S_{N}} where Sₛ = {x_{s,1}, _{Xs,2}, x_{s,3}, ■ ■ ■ , X_{s,T}}. Here, each Sₛ is a collection of the interaction data from the session s of a learner and each interaction x_{s,t} where s = 1, ■ ■ ■ , N and t = 1, ■ ■ ■ , T, which is an encoding that can represent an interaction tuple {q_{s,t}, r_{s,t}} for a particular learner, containing an identifier of a particular question attempted q_{s,t}, a binary indicator encoding the correctness of the learner’s response r_{s,t}. Let Q = {q_{s,t}} be a set of distinct questions.

Generally, the lower level model takes as input x_{s,t} and updates the estimate of knowledge state h_{s,t-1}, which is available in the lower level state bank 320, to a new estimate of the knowledge state h_{s,t} and stores it back into lower level state bank 320. Generally, lower level model 362 predicts the probability that the learner will correctly answer a question q_{s,t+1}, i.e., Prob(r_{s,t+1} = 1| q_{s,t+1}, S). Generally, the higher level model 364 transforms the knowledge state of the learner available in the lower level state bank 320, which may correspond to the knowledge state estimate at the end of a last session undertaken by the learner, to a new knowledge state, which may correspond to the state at the beginning of new session, and stores it into lower level state bank 320. The higher level model 364 also stores the output from the update step to a higher level state bank 330.

In some embodiments, hierarchical KT model 360 performs this task using supervised learning and a hierarchy of machine learning models such as bayesian models, a neural network, or the like.

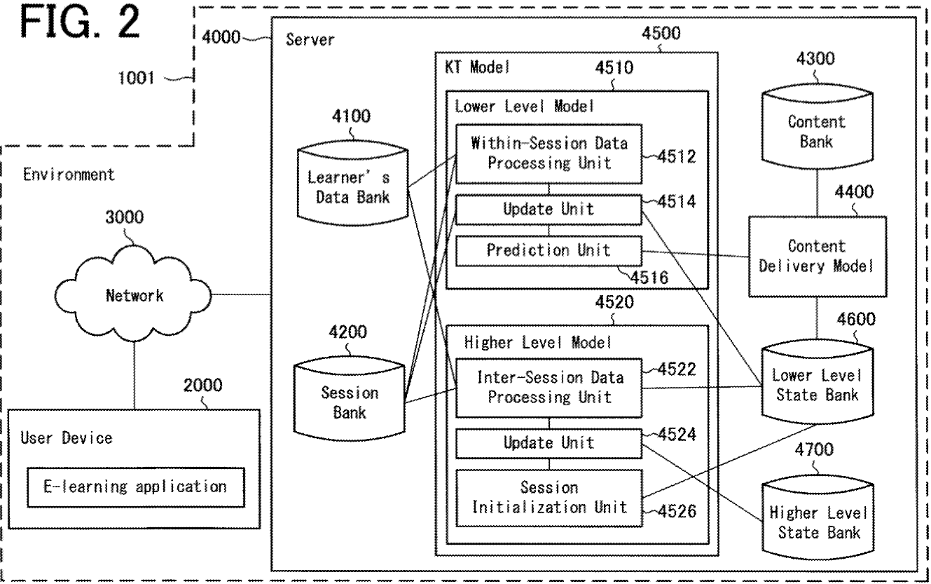

FIG. 2 is a block diagram showing an example of an environment 1001 according to an exemplary embodiment of the present invention. Environment 1001 includes user device 2000 having e-learning application. Moreover, the environment 1001 includes server 4000 that includes the hierarchical KT model 4500. In this embodiment, server 4000 provides access to KT model 4500 via network 3000.

Moreover, server 4000 includes KT model 4500, content bank 4300, learner’s data bank 4100, session bank 4200, content delivery model 4400, and lower level state bank 4600 and higher level state bank 4700, as knowledge state banks, for the lower level model 4510 and the higher level model 4520 respectively in the hierarchical KT model 4500.

Moreover, the lower level model 4510 includes within-session data processing unit 4512, update unit 4514, and prediction unit 4516, the higher level model 4520 includes inter-session data processing unit 4522, update unit 4524, and session initialization unit 4526.

Referring now to FIG. 2, a block diagram of exemplary environment 1001 that includes some added units compared to FIG. 1 to increase the modelling flexibility and utilize the additional information sometimes available in the environment 1001 is shown.

In an e-learning system, usually additional data about the learner, the learner’s interaction with the system and the learner’s environment are also collected. As a result, the interaction tuple x_{s,t} can contain some additional item-level information o_{s,t} collected in the environment such as time taken to attempt the question, type of question, concepts involved in the question, and so on. The within-session data processing unit 4512 can process and convert this additional information into a readable format for the lower level model being used. In some cases, it has shown to improve the estimation of knowledge state of a learner, thus improving the performance prediction.

Some of the additional data collected in the e-learning system can be a characteristic of an item in the interaction although some can be a characteristic of the session as a whole as well. For example, the number of questions skipped in a session, the device type (mobile or desktop based) used to access the e-learning application, affective state of learner, etc. influences the learning of a session as a whole. The within-session data processing unit 4512 in lower level model 4510 can identify such session level features (1 s) and store a transformed, model readable version of the same in the session bank 4200.

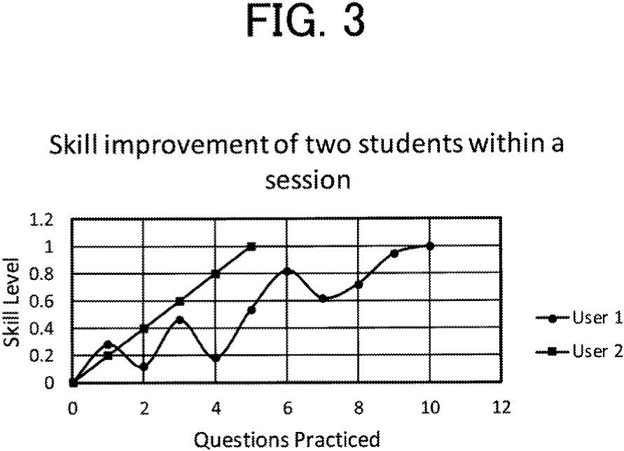

Furthermore, sometimes it could be useful to generate session level features from the inputs and the knowledge state values encountered during a session. FIG. 3 is an explanatory diagram showing an example of two learning trajectories that learners can have within a session to achieve a mastery in the skill (i.e. skill level goes from zero to one). The two trajectories are characterized by different study pattern which could be because of the difference in e-learning plan. The long term forgetting observed for the learners can be different in the two scenarios since the learner user 1 had more attempts to practice.

As a result, it may be useful to generate some features that represent the dynamics of practice and learning within a session. As an example, consider the difference series Dₛ = {d_{s,t+1} | d_{s,t+1} = h_{s,t+1} - h_{s,t} ; t = 0, ■ ■ ■ , N-1}. The statistics such as mean(Dₛ) and variance(Dₛ) of the difference series can be useful to represent the rate of and jitter in the changing learning state of learners during the session. Further, the interactions inputted to within-session data processing unit 4512 in the lower level model 4510 can be pooled together to represent the study pattern of learner. For example, the following pooling approach capture the frequency and timing of the input interactions. [Math. 1]

$$\sum {x}_{j} ln \left({\sum }_{i = 1}^{{n}_{j}} {b}_{j} {t}_{j} {}^{- {d}_{j}}\right)$$

where summation over index j in Equation (1) is used to represent distinct questions in a session, t in Equation (1) represents the time elapsed since the question attempt, b and d in Equation (1) are parameters for distinct question.

Such extracted features (eₛ) from the session input and knowledge state data are stored in the session bank 4200 by within-session data processing unit 4512 and update unit 4514 respectively.

Furthermore, some inter-session features (pₛ) are available in the environment such as time between two sessions, concepts learned while the learner was off the question-answer system, etc. A learner may undergo change in the knowledge state due to some external learning. Therefore, such inter-session features available in the learner’s data bank 4100 can be useful for the higher level model 4520 to generate a good estimate of the knowledge state of learner when the next session beings.

Inter-session data processing unit 4522 can take inputs the lower level knowledge state from lower level state bank 4600 and/or inter-session features (pₛ) from learner’s data bank 4100 and/or session-level features (1 s) from session bank 4200 and/or extracted session features (eₛ) from session bank 4200.

The update unit 4524 in higher level model 4520 takes the aggregated data from inter-session data processing unit 4522 and updates higher level hidden state Hₛ to Hₛ₊₁ and stores in the higher level state bank 4700. A session initialization unit 4526 can be used to obtain accurate h_{s+1,0} from the Hₛ₊₁ using a combination of linear and non-linear transformations.

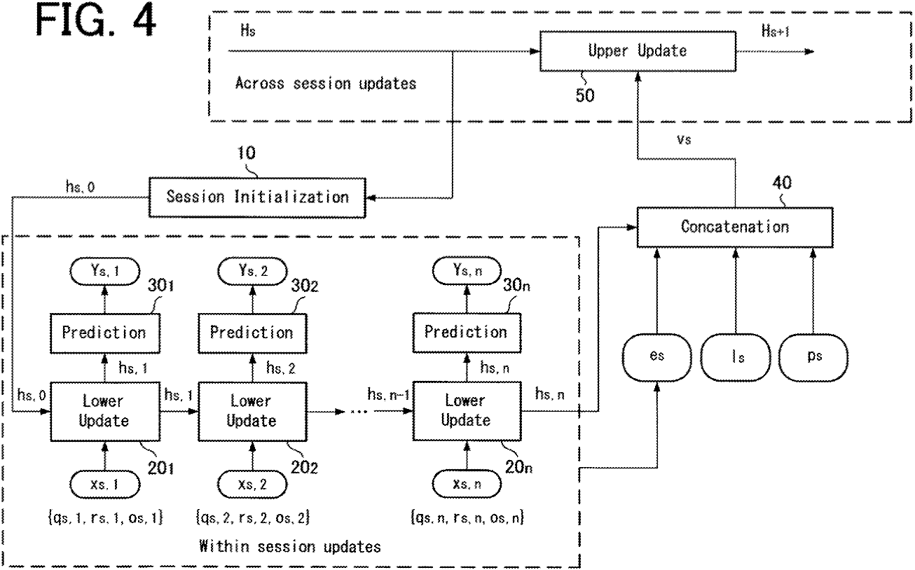

FIG. 4 is an explanatory diagram showing an example of hierarchical KT model implemented using neural networks with vanilla RNN used for sequential modelling. Exemplary hierarchical KT model shown FIG. 4 can correspond with the KT model 4500 shown FIG. 2. Generally, hierarchical KT model operates in four phases: an initialization phase, a lower level update phase, a prediction phase, and a higher level update phase.

As a learner starts a session on the e-learning systems, the lower level session RNN is initialized using the h_{s,0} which is obtained from Hₛ in session initialization 10 as, [Math. 2]

$${h}_{s , o} = T a n h \left({W}_{i} {H}_{s} + {B}_{i}\right)$$

where Wᵢ in Equation (2) is a linear transformation and Bᵢ in Equation (2) is a bias vector.

While the session is active the system usually alternates between the lower level update phase and prediction phase.

In the lower level update phase, the lower level model accepts inputs x_{s,t-1} and updates the lower level hidden state h_{s,t-1} to h_{s,t} in lower update 20₁-20ₙ as, [Math. 3]

$${h}_{s , t} = {g}_{l l} \left({W}_{l h} {h}_{s , t - 1} + {W}_{l x} {x}_{s , t - 1} + {B}_{l h}\right)$$

where W₁ₕ, W₁ₓ in Equation (3) are the linear transformations, B₁ₕ in Equation (3) is the bias vector, g₁ₗ in Equation (3) is a non-linear transformation.

In the prediction phase, the lower level model predicts the probability of solving each question (or concept). The prediction unit 4516 (also prediction 30₁-30ₙ) in the lower level model 4510 takes as input the lower level knowledge state estimate (h_{s,t}) and predicts the probabilities Y_{s,t} = {y_{s,t,1}, ■ ■ ■ , y_{s,t,M}} where each y_{s,t,m} is a real value between 0 and 1 and where m (= |Q|) is the total number of distinct questions/concepts in the domain. [Math. 4]

$${Y}_{s , t} = s i g m o i d \left({W}_{l y} {h}_{s , t + 1} + {B}_{l y}\right)$$

where W_{1y} in Equation (4) is a linear transformation and B_{1y} in Equation (4) is a bias vector.

The higher level update phase happens in the higher level model 4520. Inter-session data processing unit 4522 takes as input the lower level state h_{s,t} along with other features (such as pₛ, eₛ, 1 ₛ) and processes them in a readable format for update unit 4524 (also upper update 50). It could be a simple concatenation as in concatenation 40 to form a vector vₛ. [Math. 5]

$${v}_{s} = c o n c a t \left({h}_{s , n} ; {e}_{s} ; {l}_{s} ; {p}_{s}\right)$$

Further, the higher level state Hₛ is updated to higher level state Hₛ₊₁ in upper update 50 as, [Math. 6]

$${H}_{s + 1} = {g}_{h l} \left({W}_{h h} {H}_{s} + {W}_{h v} {v}_{s} + {B}_{h h}\right)$$

where Wₕₕ, Wₕᵥ in Equation (6) are linear transformations, Bₕₕ in Equation (6) is a bias vector and gₕ₁ in Equation (6) is a non-linear transformation. In this way a knowledge of student is traced throughout his usage of the e-learning application such as tutoring system, etc.

Standard learning techniques such as Backpropagation, Gradient Descent, Minibatching, etc. can be used to train the model with the available training data of multiple learners. The trained model is deployed in the system shown FIG. 2 (a simpler model shown FIG. 1) to enable the personalized learning on the e-learning application.

### Exemplary Flow Diagrams

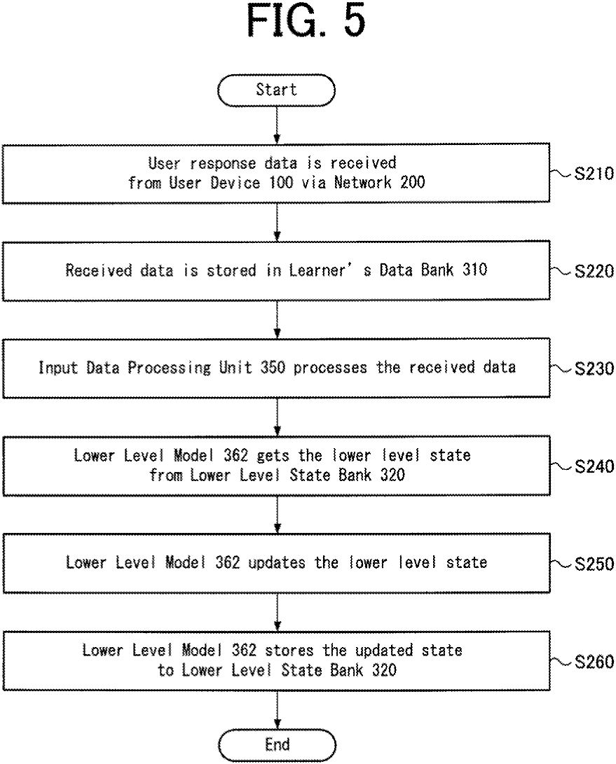

With reference now to FIGS. 5-9, flow diagrams are provided showing methods to enable personalized e-learning using systems in FIG. 1 and FIG. 2.

FIG. 5 is a flowchart showing an example of the operation of the user device 100 and the server 300 according to the exemplary embodiment of the present invention. FIG. 5 shows the method for the update of estimation of the knowledge state of learner (stored in lower level state bank 320) by the system shown FIG. 1 when the learner attempts a new question and provides a response that generates a new interaction data in the user device 100.

Initially, in step S210 the user response data is received from the user device 100 via the network 200 to the server 300 where the KT system is implemented. The method of storing and preprocessing the received data is done as in step S220 and step S230. Specifically, the received data is stored in the learner’s data bank 310 (step S220). Then, the input data processing unit 350 processes the received data (step S230).

It is followed by the update and storage of the lower level state as in steps S240-S260. Specifically, the lower level model 362 gets the lower level state from the lower level state bank 320 (step S240), updates the lower level state (step S250), stores the updated state to the lower level state bank 320 (step S260), and ends the operation. The new stored lower level state represents the system’s estimation of learner’s knowledge state.

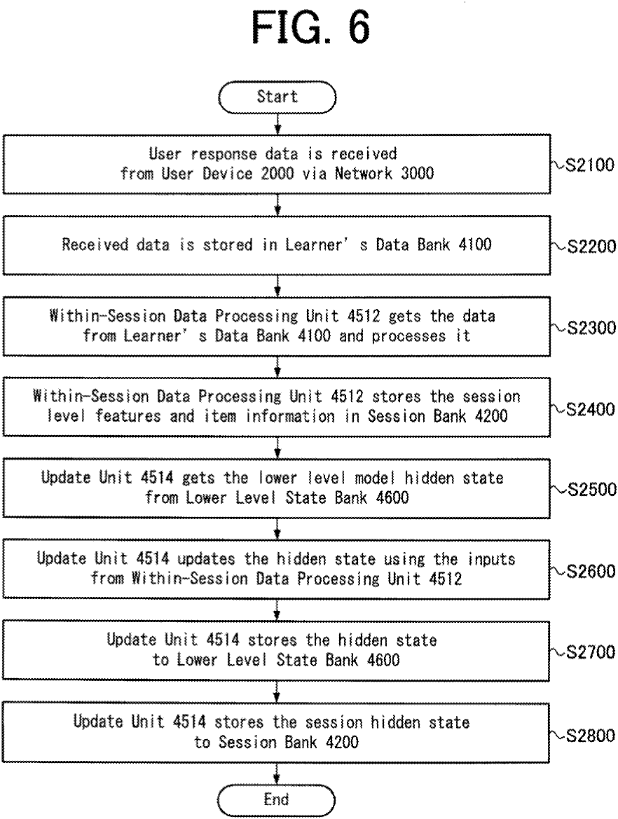

Similarly, FIG. 6 shows the method for the update of estimation of knowledge state of learner (stored in lower level state bank 4600) by the system shown FIG. 2. FIG. 6 is a flowchart showing an example of the operation of the user device 2000 and the server 4000 according to the exemplary embodiment of the present invention.

Initially, the user response data is received from the user device 2000 via the network 3000 (step S2100). The received data is stored in the learner’s data bank 4100 (step S2200). Then, the within-session data processing unit 4512 gets the data from the learner’s data bank 4100 and processes it (step S2300), and stores the session level features and item information in the session bank 4200 (step S2400).

Then, the update unit 4514 gets the lower level model hidden state from lower level state bank 4600 (step S2500), and updates the hidden state using the inputs from the within-session data processing unit 4512 (step S2600). Finally, the update unit 4514 stores the hidden state to lower level state bank 4600 (step S2700), the session hidden state to session bank 4200 (step S2800), and ends the operation.

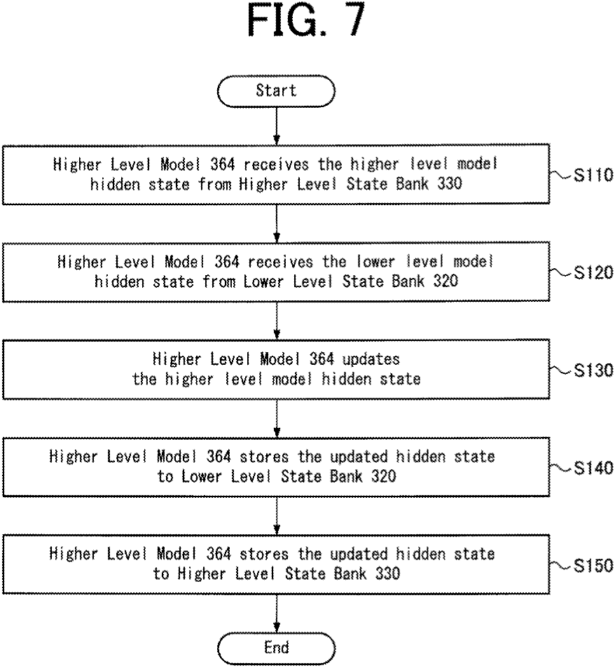

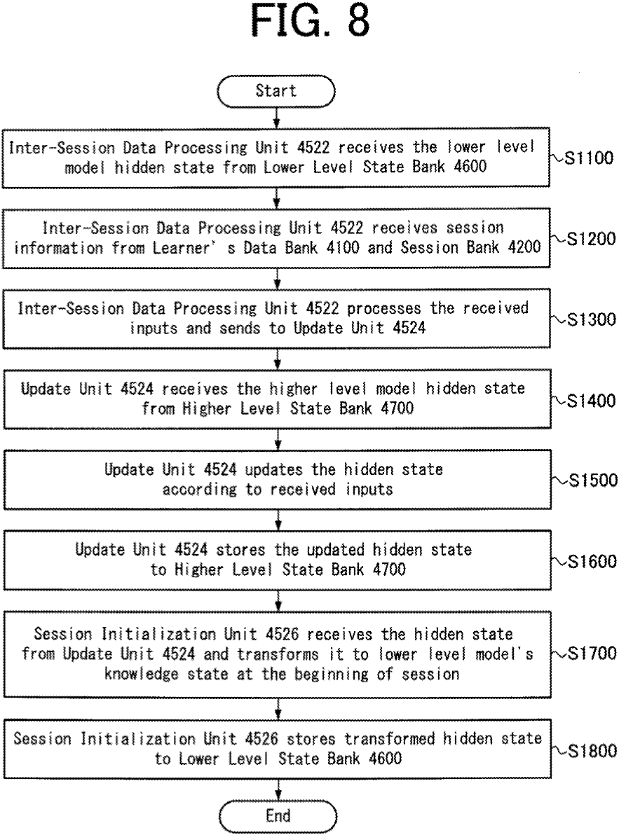

Next, FIG. 7 and FIG. 8 show the method used in systems shown FIG. 1 and FIG. 2 respectively to update the estimated knowledge state of the learner as the learner accesses the e-learning application for a new session. The process of receiving the higher and lower level state and the update of higher level state followed by storing it back to the higher and lower state banks is enabled by the higher level model 364 in system shown FIG. 1 and the higher level model 4520 in system shown FIG. 2.

FIG. 7 is a flowchart showing an example of the operation of the higher level model 364 according to the exemplary embodiment of the present invention. Initially, the higher level model 364 receives the higher level model hidden state from the higher level state bank 330 (step S110), and the lower level model hidden state from the lower level state bank 320 (step S120).

Then, the higher level model 364 updates the higher level model hidden state (step S130), stores the updated hidden state to the lower level state bank 320 and the higher level state bank 330 (steps S140-S150), and ends the operation.

FIG. 8 is a flowchart showing an example of the operation of the higher level model 4520 according to the exemplary embodiment of the present invention. Initially, the inter-session data processing unit 4522 in the higher level model 4520 receives the lower level model hidden state from the lower level state bank 4600 (step S1100), and the session information from the learner’s data bank 4100 and the session bank 4200 (step S1200). Then, the inter-session data processing unit 4522 processes the received inputs and sends to the update unit 4524 (step S1300).

Then, the update unit 4524 in the higher level model 4520 receives the higher level model hidden state from the higher level state bank 4700 (step S1400), updates the hidden state according to received inputs (step S1500), and stores the updated hidden state to the higher level state bank 4700 (step S1600).

Then, the session initialization unit 4526 in the higher level model 4520 receives the hidden state from the update unit 4524 and transforms it to lower level model’s knowledge state at the beginning of session (step S1700), stores transformed hidden state to the lower level state bank 4600 (step S1800), and ends the operating.

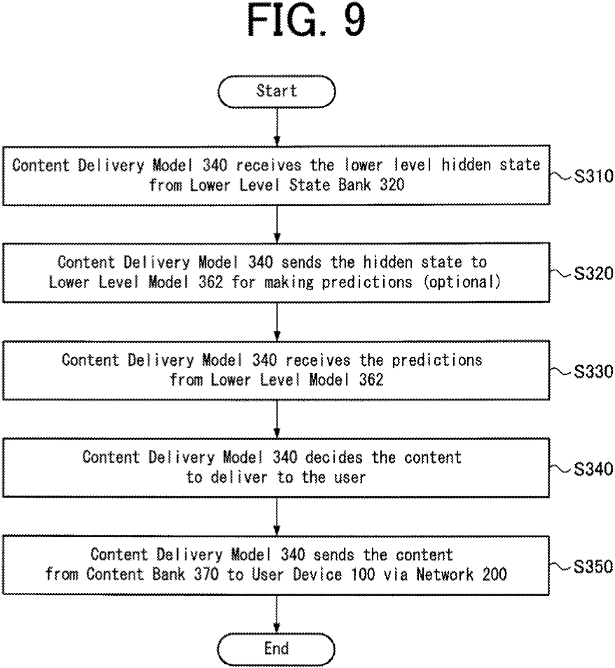

Next, FIG. 9 shows the method for delivery the next question (content) to the learner using the e-learning application 110 by the system shown FIG. 1 (similar method is used in system shown FIG. 2).

FIG. 9 is a flowchart showing an example of the operation of the content delivery model 340 according to the exemplary embodiment of the present invention. Initially, the content delivery model 340 receives the lower level hidden state from the lower level state bank 320 (step S310).

In the next step, the lower level hidden state is sent for predictions on the contents and the predictions are received back in the content delivery model 340. Specifically, the content delivery model 340 sends the hidden state to lower level model 362 for making predictions (step S320), and receives the predictions from the lower level model 362 (step S330).

However, the prediction step is optional. For example, in BKT the knowledge state represents whether the skill is mastered or not and thus, it can be used directly by the content delivery model 340.

Further, the content delivery model 340 decides the content and sends it across the network to the user. Specifically, the content delivery model 340 decides the content to deliver to the user (step S340), sends the content from the content bank 370 to the user device 100 via the network 200 (step S350), and ends the operating.

Note, the content delivery model 4400 shown in FIG. 2 executes the operation similar to the operation shown in FIG. 9.

A server 4000 for personalized e-learning includes KT model 4500 including two sequential models comprising of lower level model 4510 and higher level model 4520. The lower level model 4510 estimates and updates the estimate of knowledge state of a learner from a question-response data of the learner while the learner is active (in-session) on the e-learning application and predicts the probability of answering a question within the domain using the estimate of knowledge state. The higher level model 4520 updates the knowledge state estimate of the lower level model 4510 when a new session starts.

Moreover, the server 4000 includes content delivery model 4400 which delivers a question or a concept to the learner according to an e-learning plan that maybe based on the predicted probabilities.

Moreover, the lower level model 4510 includes within-session data processing unit 4512 which adds features about the learner’s interaction while solving the question to the question-response input data, that are made available from the e-learning application.

Moreover, the higher level model 4520 includes inter-session data processing unit 4522 which, when a new session begins, adds features that are made available from the e-learning application about the learner’s previous session on the e-learning application to the estimate of knowledge state of the lower level model 4510 at the end of last session before an update step by the higher level model 4520.

Moreover, the inter-session data processing unit 4522, when a new session begins, adds features that are made available from the e-learning application or by user about the activity of the learner between two consecutive sessions on the e-learning application to the estimate of knowledge state of the lower level model 4510 at the end of the previous of the two consecutive sessions before an update step by the higher level model 4520.

Moreover, the inter-session data processing unit 4522 extracts features from the KT model 4500 during the learner’s session and adds it to the estimate of knowledge state of the lower level model 4510 at the beginning of next session before an update step by the higher level model 4520.

Moreover, the features are extracted from the input data to the lower level model 4510 that represent at least one of the number of questions solved, the frequency of questions, or time of practice during the session.

Moreover, the features are extracted from an additional data apart from the question-response made available from the e-learning application.

Moreover, the features are extracted from the states of the lower level model 4510 during the learning session that represent the dynamics of the state of the lower level model 4510.

Moreover, the higher level model 4520 includes session initialization unit 4526 which non-linearly or linearly transforms the state of the higher level model 4520 after the update step of the higher level model 4520 to the state of the lower level model 4510 before the user starts solving questions in the new session.

In the present exemplary embodiment, techniques are described for modeling knowledge tracing taking into account the within session (online) and across-sessions (offline) behavior of a learner with respect to the learning systems. During an active session on the learning system, an intra-session model is used to maintain the knowledge state of a student. Once a learner has interacted with a question, the interaction is encoded and provided to this model to update the learner’s knowledge state during ongoing session. Once the session is over, an inter-session model is used to update the estimate of knowledge state of a learner. An accurate estimate of knowledge state of a learner helps in delivering a personalized learning plan to the learner.

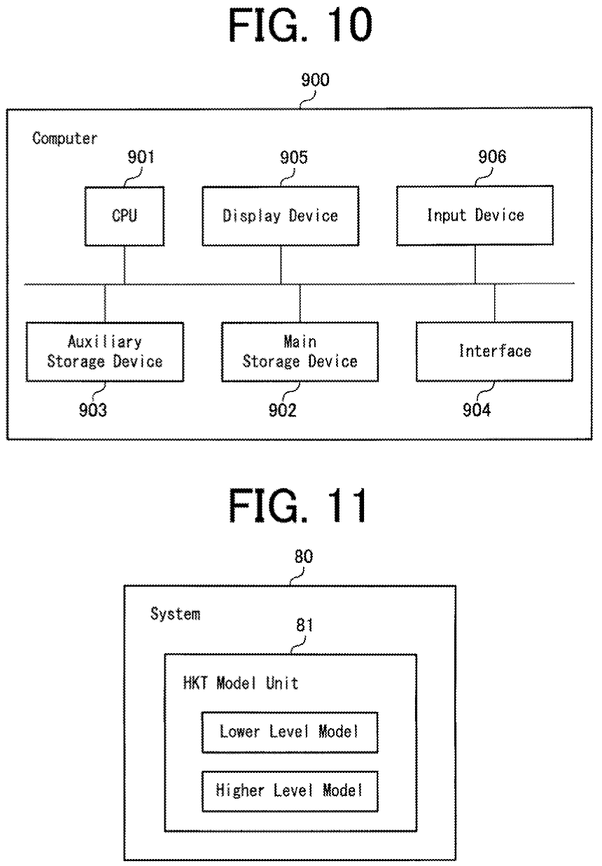

In addition, FIG. 10 is a schematic block diagram showing a configuration example of a computer according to the exemplary embodiments of the present invention. A computer 900 includes a central processing unit (CPU) 901, a main storage device 902, an auxiliary storage device 903, an interface 904, a display device 905, and an input device 906.

The servers according to the exemplary embodiment described above may be implemented by the computer 900. In this case, an operation of each of the servers may be stored in the auxiliary storage device 903 in the form of a program. The CPU 901 reads a program from the auxiliary storage device 903, develops the program in the main storage device 902, and performs predetermined processing according to the exemplary embodiment, in accordance with the program. Note that the CPU 901 is an example of an information processing device that operates according to a program, and, for example, a micro processing unit (MPU), a memory control unit (MCU), a graphics processing unit (GPU), or the like may be included rather than a CPU.

The auxiliary storage device 903 is an example of a non-transitory tangible medium. Other examples of the non-transitory tangible medium include a magnetic disk, a magneto-optical disk, a Compact Disc Read only memory (CD-ROM), a DVD-ROM, a semiconductor memory, and the like that are connected via the interface 904. In a case where this program is distributed to the computer 900 via a communication line, a computer 900 that has received distribution may develop the program in the main storage device 902, and may perform predetermined processing according to the exemplary embodiment.

The program may be a program for implementing part of predetermined processing according to the exemplary embodiment described above. Further, the program may be a differential program for implementing the predetermined processing according to the exemplary embodiment in combination with another program that has already been stored in the auxiliary storage device 903.

The interface 904 transmits or receives information to or from another device. The display device 905 presents information to a user. The input device 906 receives an input of information from a user.

Depending on the content of processing according to an exemplary embodiment, some components of the computer 900 can be omitted. For example, if the computer 900 does not present information to a user, the display device 905 can be omitted. For example, if the computer 900 does not receive information from a user, the input device 906 can be omitted.

Some or all of respective components according to the exemplary embodiments described above are implemented by general-purpose or dedicated circuitry, a processor, or the like, or a combination thereof. They may be configured by a single chip, or may be configured by a plurality of chips connected via a bus. Some or all of the respective components according to the exemplary embodiment described above may be implemented by a combination of the circuitry described above or the like and a program.

In a case where some or all of the respective components according to the exemplary embodiment described above are implemented by a plurality of information processing devices, pieces of circuitry, or the like, the plurality of information processing devices, the pieces of circuitry, or the like may be concentratedly disposed or may be distributed and disposed. For example, the information processing devices, the pieces of circuitry, or the like may be implemented in the form of connection to each other via a communication network, such as a client and server system or a cloud computing system.

Next, an outline of the present invention is described. FIG. 11 is a block diagram showing an outline of a system according to the present invention. FIG. 11 shows a system 80 for personalized e-leaming. The system 80 includes a Hierarchical Knowledge Tracing (HKT) model unit 81 (for example, the KT model 4500) which includes two sequential models comprising of a lower level model (for example, the lower level model 4510) and a higher level model (for example, the higher level model 4520), wherein the lower level model estimates and updates the estimate of knowledge state of a learner from a question-response data of the learner while the learner is active (in-session) on the e-learning application and predicts the probability of answering a question within the domain using the estimate of knowledge state, and the higher level model updates the knowledge state estimate of the lower level model when a new session starts.

With the structure, the system can model the learner’s changing knowledge state within a session and across two sessions separately.

Further, the system 80 may include a content delivery model unit (for example, the content delivery model 4400) which delivers a question or a concept to the learner according to an e-learning plan that maybe based on the predicted probabilities.

With the structure, the system can deliver a question or a concept based on the predicted probabilities.

Further, the system 80 may include a data processing unit (for example, the within-session data processing unit 4512) which adds features about the learner’s interaction while solving the question to the question-response input data, that are made available from the e-learning application.

With the structure, the system can model the learner’s changing knowledge state within a session more accurately.

Further, the system 80 may include an inter-session data processing unit (for example, the inter-session data processing unit 4522) which, when a new session begins, adds features that are made available from the e-learning application about the learner’s previous session on the e-learning application to the estimate of knowledge state of the lower level model at the end of last session before an update step by the higher level model.

Further, the inter-session data processing unit may, when a new session begins, add features that are made available from the e-learning application or by user about the activity of the learner between two consecutive sessions on the e-learning application to the estimate of knowledge state of the lower level model at the end of the previous of the two consecutive sessions before an update step by the higher level model.

With the structure, the system can model the learner’s changing knowledge state across two sessions more accurately.

Further, the inter-session data processing unit may extract features from the HKT model unit 81 during the learner’s session and add it to the estimate of knowledge state of the lower level model at the beginning of next session before an update step by the higher level model.

Further, the features may be extracted from the input data to the lower level model that represent at least one of the number of questions solved, the frequency of questions, or time of practice during the session.

Further, the features may be extracted from an additional data apart from the question-response made available from the e-learning application.

Further, the features may be extracted from the states of the lower level model during the learning session that represent the dynamics of the state of the lower level model.

With the structure, the system can model the learner’s changing knowledge state across two sessions more accurately.

Further, the system 80 may include a session initialization unit (for example, the session initialization unit 4526) which non-linearly or linearly transforms the state of the higher level model after the update step of the higher level model to the state of the lower level model before the user starts solving questions in the new session.

With the structure, the system can transform the higher level model hidden state to lower level model’s knowledge state.

Note that the above exemplary embodiment can also be described as the following supplementary notes.

(Supplementary note 1) A system for personalized e-learning, the system comprising: a Hierarchical Knowledge Tracing (HKT) model unit including two sequential models comprising of a lower level model and a higher level model, wherein the lower level model estimates and updates the estimate of knowledge state of a learner from a question-response data of the learner while the learner is active (in-session) on the e-learning application and predicts the probability of answering a question within the domain using the estimate of knowledge state, and the higher level model updates the knowledge state estimate of the lower level model when a new session starts.

(Supplementary note 2) The system according to supplementary note 1, further comprising: a content delivery model unit which delivers a question or a concept to the learner according to an e-learning plan that maybe based on the predicted probabilities.

(Supplementary note 3) The system according to supplementary note 1 or 2, further comprising: a data processing unit which adds features about the learner’s interaction while solving the question to the question-response input data, that are made available from the e-learning application.

(Supplementary note 4) The system according to any one of supplementary notes 1 to 3, further comprising: an inter-session data processing unit which, when a new session begins, adds features that are made available from the e-learning application about the learner’s previous session on the e-learning application to the estimate of knowledge state of the lower level model at the end of last session before an update step by the higher level model.

(Supplementary note 5) The system according to supplementary note 4, wherein the inter-session data processing unit, when a new session begins, adds features that are made available from the e-learning application or by user about the activity of the learner between two consecutive sessions on the e-learning application to the estimate of knowledge state of the lower level model at the end of the previous of the two consecutive sessions before an update step by the higher level model.

(Supplementary note 6) The system according to supplementary note 4 or 5, wherein the inter-session data processing unit extracts features from the HKT model unit during the learner’s session and adds it to the estimate of knowledge state of the lower level model at the beginning of next session before an update step by the higher level model.

(Supplementary note 7) The system according to supplementary note 6, wherein the features are extracted from the input data to the lower level model that represent at least one of the number of questions solved, the frequency of questions, or time of practice during the session.

(Supplementary note 8) The system according to supplementary note 6 or 7, wherein the features are extracted from an additional data apart from the question-response made available from the e-learning application.

(Supplementary note 9) The system according to any one of supplementary notes 6 to 8, wherein the features are extracted from the states of the lower level model during the learning session that represent the dynamics of the state of the lower level model.

(Supplementary note 10) The system according to any one of supplementary notes 1 to 9, further comprising: a session initialization unit which non-linearly or linearly transforms the state of the higher level model after the update step of the higher level model to the state of the lower level model before the user starts solving questions in the new session.

(Supplementary note 11) A device for personalized e-learning, the device comprising: a Hierarchical Knowledge Tracing (HKT) model unit including two sequential models comprising of a lower level model and a higher level model, wherein the lower level model estimates and updates the estimate of knowledge state of a learner from a question-response data of the learner while the learner is active (in-session) on the e-learning application and predicts the probability of answering a question within the domain using the estimate of knowledge state, and the higher level model updates the knowledge state estimate of the lower level model when a new session starts.

(Supplementary note 12) A method for personalized e-learning, the method comprising: estimating and updating the estimate of knowledge state of a learner from a question-response data of the learner while the learner is active (in-session) on the e-learning application; predicting the probability of answering a question within the domain using the estimate of knowledge state; and updating the knowledge state estimate when a new session starts.

(Supplementary note 13) A program for personalized e-learning causing a computer to perform a process comprising: estimating and updating the estimate of knowledge state of a learner from a question-response data of the learner while the learner is active (in-session) on the e-learning application; predicting the probability of answering a question within the domain using the estimate of knowledge state; and updating the knowledge state estimate when a new session starts.

The invention of the present application has been described above with reference to the exemplary embodiments and the example, but the invention of the present application is not limited to the exemplary embodiments and the example that have been described above. Various changes that those skilled in the art could understand can be made to the configuration or details of the invention of the present application without departing from the scope of the invention of the present application.

Reference Signs List

| | |
|---|---|
| 80 | system |
| 81 | Hierarchical Knowledge Tracing (HKT) model unit |
| 100, 2000 | user device |
| 110 | e-learning application |
| 200, 3000 | network |
| 300, 4000 | server |
| 310, 4100 | learner’s data bank |
| 320,4600 | lower level state bank |
| 330, 4700 | higher level state bank |
| 340, 4400 | content delivery model |
| 305 | input data processing unit |
| 360, 4500 | Knowledge Tracing (KT) model |
| 362, 4510 | lower level model |
| 364, 5420 | higher level model |
| 370, 4300 | content bank |
| 900 | computer |
| 901 | central processing unit (CPU) |
| 902 | main storage divice |
| 903 | auxiliary storage device |
| 904 | interface |
| 905 | display device |
| 906 | input device |
| 1000,1001 | environment |
| 4200 | session bank |
| 4512 | within-session data processing unit |
| 4514, 4524 | update unit |
| 4516 | prediction unit |
| 4522 | inter-session data processing unit |
| 4526 | session initialization unit |

What is claimed is:

1. A system for personalized e-learning, the system comprising:
a memory configured to store instructions:
a processor configured to execute the instructions: and
a Hierarchical Knowledge Tracing (HKT) model including two sequential models comprising of a lower level model and a higher level model, wherein
the lower level model estimates and updates the estimate of knowledge state of a learner from a question-response data of the learner while the learner is active (in-session) on the e-learning application and predicts the probability of answering a question within the domain using the estimate of knowledge state, and
the higher level model updates the knowledge state estimate of the lower level model when a new session starts.

2. The system according to claim 1, wherein the processor is further configured to execute the instructions to:
deliver a question or a concept to the learner according to an e-learning plan that maybe based on the predicted probabilities.

3. The system according to claim 1, wherein the processor is further configured to execute the instructions to:
add features about the learner’s interaction while solving the question to the question-response input data, that are made available from the e-learning application.

4. The system according to claim 1, wherein the processor is further configured to execute the instructions to:
when a new session begins, add features that are made available from the e-learning application about the learner’s previous session on the e-learning application to the estimate of knowledge state of the lower level model at the end of last session before an update step by the higher level model.

5. The system according to claim 4, wherein the processor is further configured to execute the instructions to:
when a new session begins, add features that are made available from the e-learning application or by user about the activity of the learner between two consecutive sessions on the e-learning application to the estimate of knowledge state of the lower level model at the end of the previous of the two consecutive sessions before an update step by the higher level model.

6. The system according to claim 4, wherein the processor is further configured to execute the instructions to:
extract features from the HKT model during the learner’s session and adds it to the estimate of knowledge state of the lower level model at the beginning of next session before an update step by the higher level model.

7. The system according to claim 6, wherein
the features are extracted from the input data to the lower level model that represent at least one of the number of questions solved, the frequency of questions, or time of practice during the session.

8. The system according to claim 6, wherein
the features are extracted from an additional data apart from the question-response made available from the e-learning application.

9. The system according to claim 6, wherein
the features are extracted from the states of the lower level model during the learning session that represent the dynamics of the state of the lower level model.

10. The system according to claim 1, wherein the processor is further configured to execute the instructions to:
non-linearly or linearly transform the state of the higher level model after the update step of the higher level model to the state of the lower level model before the user starts solving questions in the new session.

11. A device for personalized e-learning, the device comprising:
a memory configured to store instructions:
a processor configured to execute the instructions: and
a Hierarchical Knowledge Tracing (HKT) model including two sequential models comprising of a lower level model and a higher level model, wherein
the lower level model estimates and updates the estimate of knowledge state of a learner from a question-response data of the learner while the learner is active (in-session) on the e-learning application and predicts the probability of answering a question within the domain using the estimate of knowledge state, and
the higher level model updates the knowledge state estimate of the lower level model when a new session starts.

12. A method for personalized e-learning, the method comprising:
estimating and updating the estimate of knowledge state of a learner from a question-response data of the learner while the learner is active (in-session) on the e-learning application;
predicting the probability of answering a question within the domain using the estimate of knowledge state; and
updating the knowledge state estimate when a new session starts.

13. (canceled)
